(19) United States
(12) Patent Application Publication
(10) Pub. No.: US 2010/0296060 A1
(43) Pub. Date: Nov. 25, 2010

(54) INTEGRATED MICRODISPLAY PROJECTION AND IMAGING SYSTEM

(75) Inventor: HERB HE HUANG, SHANGHAI (CN)

Correspondence Address: J C PATENTS, 4 VENTURE, SUITE 250, IRVINE, CA, 92618, US

(73) Assignee: JIANGSU LEXVU ELECTRONICS CO., LTD, JIANGSU (CN)

(21) Appl. No.: 12/785,691

(22) Filed: May 24, 2010

Related U.S. Application Data
(60) Provisional application No. 61/180,712, filed on May 22, 2009.

(51) Int. Cl. G03B 21/14

(52) U.S. Cl. 353/20

(57) ABSTRACT

An integrated microdisplay projection and imaging system includes: a focus-adjustable lens system, a planar polarization beam splitter, a reflective polarization modulation imager and an imaging sensor with a post polarizer in orthogonal polarization orientation to the planar polarization beam splitter, as well as a lighting module. Placed on two separate sides of the planar polarization beam splitter, the reflective polarization modulation imager and the imaging sensor have substantially equal-length optical passes through the planar polarization beam splitter to the focus-adjustable lens system, and thus the focus-adjustable lens system provides a unified means for adjusting focus with both the reflective polarization modulation imager and the imaging sensor, relative to an external object such a projection screen or an imaging object.

### CROSS-REFERENCE TO RELATED APPLICATIONS

This application claims priority of provisional application No. 61/180,712, filed on May 22, 2009, entitled “Integrated Microdisplay Projection and Imaging System”, which is incorporated herein by reference in its entirety.

### FIELD OF THE TECHNOLOGY

The present invention relates to an integrated optical system incorporating a single-panel microdisplay imager and an imaging sensor, capable of both producing projection display and facilitating image sensing.

### BACKGROUND

Increasing demand for portable digital display with cell phone and other handhelds is giving rise to an emerging and expanding market for micro or pico projectors employing a simple but effective projection optical engine based on a single panel microdisplay imager such as digital light procession (DLP) and liquid crystal on silicon (LCOS) as well as miniaturized illumination sources such as LED and laser in a substantially compact configuration. Furthermore, interest also arises in integrating a miniaturized camera with such a portable display system, not only for miniaturizing and/or simplifying such a handheld electronic system, but also for elaborating and expanding integrated capability of both projection display and video imaging.

However, incorporation of an image and video sensing device with a micro or pico projection optical engine, preferably effectively on function and cost perspectives, is by no means straight forward. In particular, several technical issues surface as technical challenges to the system design and implementation: 1) high intensity illumination for projection versus imaging under low intensity illumination; 2) optical paths for both projection and imaging through the same optical engine and lens system; and 3) opto-electronic interference or cross talk between projection and imaging or their enabling integrated circuits, besides others. The prior art in a number of references fail to address one or more if not all of those critical issues as disclosed. For example, in a single-DLP panel microdisplay projection system, a total internal reflection (TIR) is employed for managing the optical paths for illuminating the DLP imager by a collimated light source and meanwhile, guiding the projection image from the DLP imager towards and through a projection lens simultaneously. Simply placing an imaging sensor on the other side of the TIR from the DLP imager would not facilitate needed light path management for imaging from an external object through a projection lens, though focus-adjusted, and the TIR to the imaging sensor, as imaging light from the external object through the projection lens mostly passes through the TIR rather is reflected to the imaging sensor. The related prior art for a LCOS microdisplay rear projection display system incorporating an image sensor for adjusting a projection image as disclosed also fails to address some of the listed issues, at least effectively on the opto-electronic interference and cross talk perspective, which requires deliberate optical design and integration of two constituent but contrary subsystems.

### SUMMARY

The present invention provides an integrated microdisplay projection and imaging system capable of producing projection display and facilitating image sensing while effectively addressing the above mentioned technical issues.

According to one aspect of the present invention, an integrated microdisplay projection and imaging system includes:

1) a focus-adjustable lens system with a principal axis;

2) a planar polarization beam splitter configured facing the focus-adjustable lens system in a facing angle substantially close to 45-degree with the principal axis;

3) a reflective polarization modulation imager configured on first side of and in a reflection angle substantially close to 45-degree with the planar polarization beam splitter;

4) an imaging sensor configured on second side of and in an imaging angle substantially close to 45-degree with the planar polarization beam splitter; and

5) a lighting module inducing collimated source illumination in an incident angle substantially close to 45-degree with the planar polarization beam splitter.

Therein respectively with the reflective polarization modulation imager and the imaging sensor optically aligned with the principal axis of the focus-adjustable lens system, the optical path distance for projection and the optical path distance for imaging are configured substantially equal first through the planar polarization beam splitter and along the principal axis to the focus-adjustable lens system; therefore, the focus-adjustable lens system is set being capable of providing focus adjustment means for both the reflective polarization modulation imager and the imaging sensor, relative to an external object.

In an embodiment of the present invention, such an integrated microdisplay projection and imaging system further incorporates one or both of the following:

1) a pre polarizer in orthogonal polarization orientation to the planar polarization beam splitter, placed between the lighting module and the planar polarization beam splitter; and

2) a post polarizer in orthogonal polarization orientation to the planar polarization beam splitter, placed between the imaging sensor and the planar polarization beam splitter;

for eliminating the cross talk of the imaging sensor with collimated source illumination from the lighting module to the planar polarization beam splitter and later to the reflective polarization modulation imager.

### BRIEF DESCRIPTION OF THE DRAWINGS

These and other objectives of the present invention would become understandable to those of ordinary skills in the art after reading the following detailed description of the preferred embodiment that is illustrated in the various figures and drawings. The present invention may be more thoroughly understood in consideration of the following detailed description of various embodiments in connection with the accompanying drawings, in which:

FIG. 1 is a cross-sectional diagram of an integrated microdisplay projection and imaging system in an embodiment of the present invention;

FIG. 2 is a cross-sectional diagram of an integrated microdisplay projection and imaging system in another embodiment of the present invention;

FIG. 3 is a cross-sectional diagram of an integrated microdisplay projection and imaging system in another embodiment of the present invention;

FIG. 4 is a cross-sectional diagram of an integrated microdisplay projection and imaging system in another embodiment of the present invention;

FIGS. 5a and 5b are cross-sectional diagrams of an imaging sensor incorporating a post polarizer in another embodiment of present invention.

### DETAILED DESCRIPTION

The present invention is not so limited; an appreciation of various aspects of the disclosure will be gained through a discussion of the examples provided below.

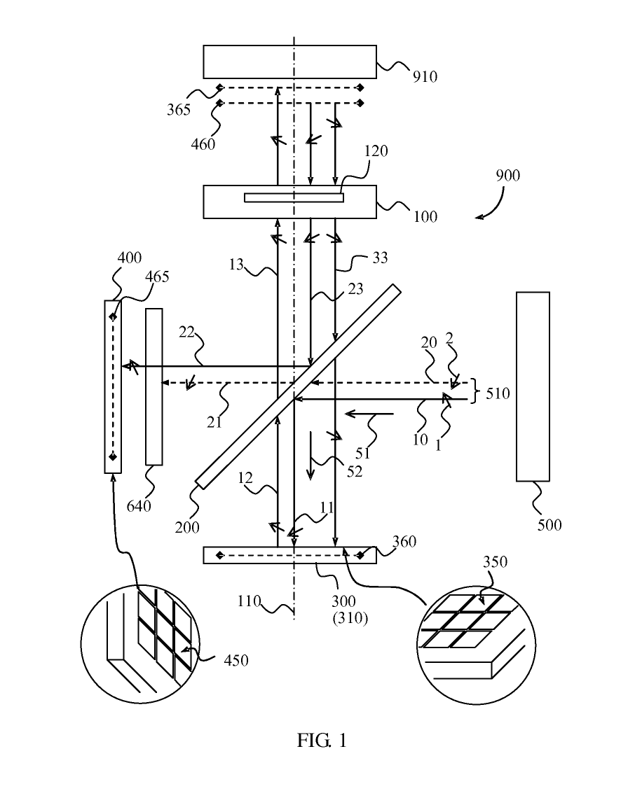

FIG. 1 is a cross-sectional diagram of an integrated microdisplay projection and imaging system 900 in basic embodiments of the present invention. As shown, the integrated microdisplay projection and imaging system 900 includes: 1) a focus-adjustable lens system 100 with a principal axis 110; 2) a planar polarization beam splitter 200 configured facing the focus-adjustable lens system 100 in a facing angle substantially close to 45-degree with the principal axis 110; 3) a reflective polarization modulation imager 300 configured on first side of and in a reflection angle substantially close to 45-degree with the planar polarization beam splitter 200; 4) an imaging sensor 400 configured on second side of and in an imaging angle substantially close to 45-degree with the planar polarization beam splitter 200; and 5) a lighting module 500 inducing collimated illumination in an incident angle substantially close to 45-degree with the planar polarization beam splitter 200.

The lighting module 500 provides collimated source illumination 510 along a first direction 51 towards and in an incident angle close to 45-degree relative to the planar polarization beam splitter 200, consisting of a first polarization source illumination 10 in first polarization state 1 and a second polarization source illumination 20 in second polarization state 2. The first polarization source illumination 10 is reflected by the planar polarization beam splitter 200 as the imager-incident illumination 11 in first polarization state 1 towards the reflective polarization modulation imager 300 in a second direction 52. Through modulation while polarization rotation by 90-degree, a polarization modulated image beam 12 in second polarization state 2 is generated and sent by the reflective polarization modulation imager 300 towards and then partially passes through the planar polarization beam splitter 200, as a polarization modulated projection beam 13. Through the focus-adjustable lens system 100, the polarization modulated projection beam 13 in second polarization state 2 is projected unto an external object 910, such a projection screen or an imaging object, for forming a projection image 365, replicating an original signal image 360 generated on the reflective polarization modulation imager 300.

The system 900 further includes a post polarizer 640 in orthogonal polarization orientation to the planar polarization beam splitter 200, configured between the planar polarization beam splitter 200 and the imaging sensor 400. The second polarization source illumination 20 in second polarization state 2 passes through the planar polarization beam splitter 200 as a second polarization illumination 21 but is substantially blocked or reflected back by a post polarizer 640 before reaching the imaging sensor 400. Thus, optical interference and cross talk between projection display and imaging is thus minimized, particularly the same reduced of the lighting module 500 with the imaging sensor 400.

An external image 460 of the external object 910 generates image light beams in two polarization states, first polarization image illumination 23 in first polarization state 1 and second polarization image illumination 33 in second polarization state 2. The first polarization image illumination 23 is then reflected by the planar polarization beam splitter 200, as an imaging-incident polarization illumination 22 in first polarization state 1, towards the post polarizer 640, while substantial portion of second polarization image illumination 33 in second polarization state 2 passes through the planar polarization beam splitter 200 towards the reflective polarization modulation imager 300. Substantial portion of the imaging-incident polarization illumination 22 in first polarization state 1 passes through the post polarizer 640, illuminating the imaging sensor 400 which generates electronic signals of a sensed image 465, corresponding to the external image 460. Meanwhile, in order to adequately adjust exposure intensity of the imaging-incident polarization illumination 22 onto the imaging sensor 400, an aperture adjuster 120 is further incorporated into the focus-adjustable lens system 100 for adjusting aperture and thus adjusting light inductance for imaging through the focus-adjustable lens system 100 eventually unto the imaging sensor 400 and light inductance for projection through the focus-adjustable lens system 100 from the reflective polarization modulation imager 300 and the lighting module 500.

The reflective polarization modulation imager 300 is composed of a planar array of modulation pixels 350 in a regularly tiled planar arrangement, while the imaging sensor 400 composed of another array of image sensing pixels 450 in another regularly tiled planar arrangement as shown in FIG. 1, both optionally fabricated readily on silicon substrates. The present embodiment employs a liquid crystal on silicon microdisplay imager 310 as the reflective polarization modulation imager 300.

The embodiment of the present invention provides an integrated microdisplay projection and imaging system capable of producing projection display and facilitating image sensing, which may be considered to be widely applicable to various microdisplay projection systems, in particular, single-imager microdisplay projection systems.

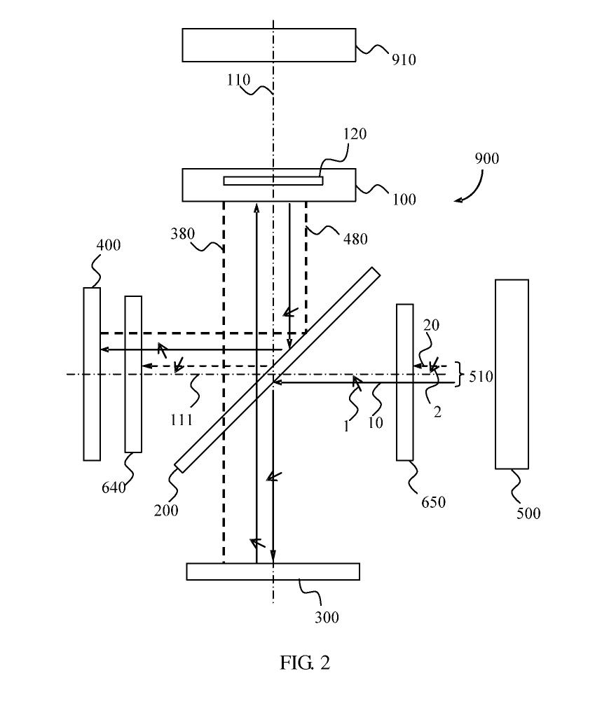

FIG. 2 is a cross-sectional diagram of an integrated microdisplay projection and imaging system 900 in another embodiment of the present invention. As shown in FIG. 2, the optical pass distance for projection 380, measured from the reflective polarization modulation imager 300 through the planar polarization beam splitter 200 to the focus-adjustable lens system 100, is adequately configured substantially equal to the optical pass distance for imaging 480, from the imaging sensor 400 through the planar polarization beam splitter 200 to the focus-adjustable lens system 100. Such deliberate optical arrangement provides unified means for adjusting the optical focus of the reflective polarization modulation imager 300 and the imaging sensor 400 relative to an external object 910.

FIG. 2 further illustrates another embodiment of present invention, particularly on an alternative feature for eliminating interference of collimated source illumination 510 from the lighting module 500 with the imaging sensor 400 by installing a pre polarizer 650 with a principal axis 111 between the lighting module 500 and the planar polarization beam splitter 200. Also in orthogonal polarization orientation to the planar polarization beam splitter 200, the pre polarizer 650 would provide additional filtering of polarization light in second polarization state 2 to the post polarizer 640, for the imaging sensor 400 to achieve improved signal to noise performance, even under a dual-mode working mode, that is, when both projection and imaging functions are turned on for simultaneous operation.

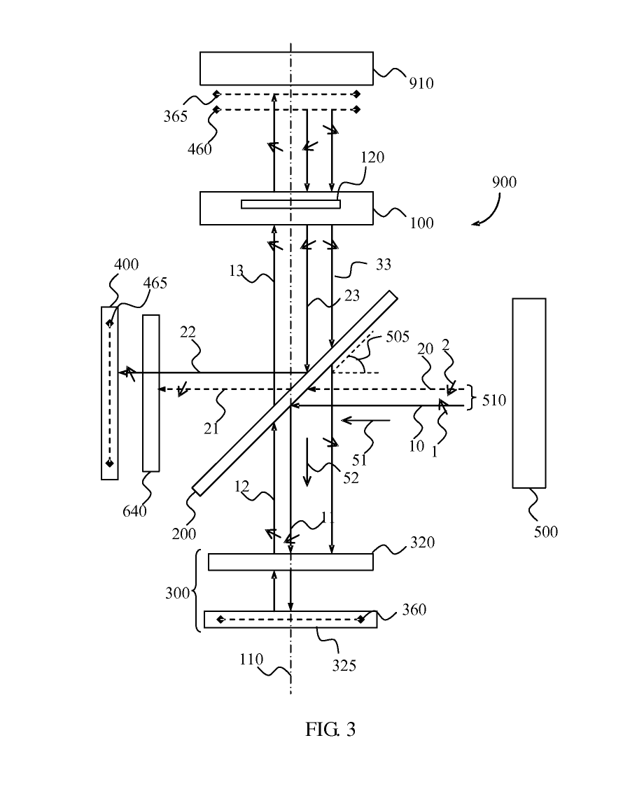

FIG. 3 is a cross-sectional diagram of an integrated microdisplay projection and imaging system 900 in another embodiment of the present invention. In the present embodiment, the reflective polarization modulation imager 300 includes a quarter wave retarder plate 320 and a MEMS-based diffractive spatial light modulation imager 325 configured in parallel in the imaging angle substantially close to 45-degree with the planar polarization beam splitter 200. The quarter wave retarder plate 320 is placed between the diffractive spatial light modulation imager 325 and the planar polarization beam splitter 200. The quarter wave retarder plate 320 and the MEMS-based diffractive spatial light modulation imager 325 jointly provide equivalent reflective polarization modulation to the imager-incident illumination 11 as through the liquid crystal on silicon microdisplay imager 310 (as shown in FIG. 1).

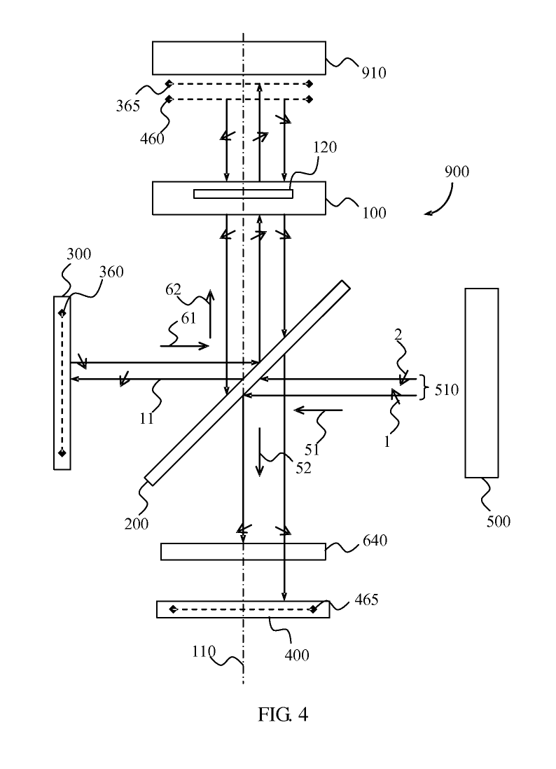

FIG. 4 is a cross-sectional diagram of an integrated microdisplay projection and imaging system 900 in another embodiment of the present invention, in particular, alternative but equivalent spatial arrangement of the reflective polarization modulation imager 300 and the imaging sensor 400 relative to the planar polarization beam splitter 200. Still placed on two sides of the planar polarization beam splitter 200, the reflective polarization modulation imager 300 and the imaging sensor 400 are switched in position (from the configuration shown in FIG. 1), while the reflective polarization modulation imager 300 alternatively operates with the imager-incident illumination 11 in second polarization state 2. And still the planar polarization beam splitter 200 reflects illumination in first polarization state 1 and let pass illumination in second polarization state 2, while the post polarizer 640 does just the opposite.

As illustrated in all the above figures, for achieving desired optical performance, any of the other four key components of the integrated microdisplay projection and imaging system 900 other than the planar polarization beam splitter 200 is configured in an inclined angle substantially close to 45-degree with the planar polarization beam splitter 200: the focus-adjustable lens system 100, the reflective polarization modulation imager 300, the imaging sensor 400 with the post polarizer 640 and the lighting module 500.

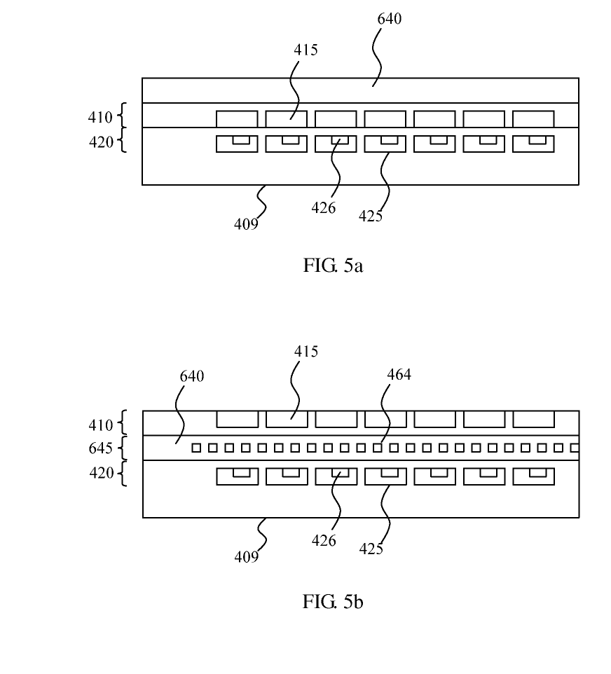

FIG. 5a is a cross-sectional diagram of an structure of the imaging sensor 400 incorporating a post polarizer 640 in the above embodiments of the present invention. FIG. 5b is a cross-sectional diagram of another structure of the imaging sensor 400 incorporating a post polarizer 640 in the above embodiments of the present invention. The post polarizer 640 in each FIG. 5a and FIG. 5b is integrated a in a thin film configuration onto the imaging sensor 400. The imaging sensor 400 includes a planar array 410 of color filter elements 415; and a planar array 420 of photo sensing pixels 425 optical aligned with the color filter elements 415, each photo sensing pixel 425 comprising at least a photo diode 426 on a semiconductor substrate 409.

As shown in FIG. 5a, the post polarizer 640 is formed in adherence unto the planar array 410 of color filter elements 415 as a composite film composed of multiple optical index matching layers. Alternatively as shown in FIG. 5b, such a post polarizer 640 in a thin film configuration is formed between the planar array 410 of color filter elements 415 and the planar array 420 of photo sensing pixels 425, each photo sensing pixel 425 containing at least one photo diode 426. For example, such a thin film of post polarizer 640 is constructed as a wire grid polarizer 645 consisting of multiple elongated reflective metal strips 464. Such a linear array of multiple elongated reflective metal strips 464 is readily fabricated on top of the backend device stack of an imaging sensor chip on a silicon substrate 409.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An integrated microdisplay projection and imaging system comprising:
a focus-adjustable lens system with a principal axis;
a planar polarization beam splitter configured facing the focus-adjustable lens system in a facing angle close to 45-degree with the principal axis;
a reflective polarization modulation imager configured on first side of and in a reflection angle close to 45-degree with the planar polarization beam splitter;
an imaging sensor configured on second side of and in an imaging angle close to 45-degree with the planar polarization beam splitter;
a lighting module inducing collimated illumination in an incident angle close to 45-degree with the planar polarization beam splitter;
wherein an optical pass distance for projection, measured from the reflective polarization modulation imager through the planar polarization beam splitter to the focus-adjustable lens system, is configured equal to an optical pass distance for imaging, from the imaging sensor through the planar polarization beam splitter to the focus-adjustable lens system.

2. The system according to claim 1, further comprising a post polarizer in orthogonal polarization orientation to the planar polarization beam splitter, configured between the planar polarization beam splitter and the imaging sensor.

3. The system according to claim 1, further comprising a pre polarizer in orthogonal polarization orientation to the planar polarization beam splitter, configured between the planar polarization beam splitter and the lighting module.

4. The system according to claim 1, wherein the reflective polarization modulation imager 300 is a liquid crystal on silicon microdisplay imager.

5. The system according to claim 1, wherein the reflective polarization modulation imager comprises a quarter wave retarder plate and a MEMS-based diffractive spatial light modulation imager configured in parallel in the imaging angle substantially close to 45-degree with the planar polarization beam splitter wherein the quarter wave retarder plate is placed between the diffractive spatial light modulation imager and the planar polarization beam splitter.

6. The system according to claim 1, wherein the focus-adjustable lens system further includes an aperture adjuster for adjusting light inductance for imaging through the focus-adjustable lens system eventually unto the imaging sensor and light inductance for projection through the focus-adjustable lens system from the reflective polarization modulation imager and the lighting module.

7. The system according to claim 2, wherein the post polarizer is integrated in a thin film configuration onto the imaging sensor.

8. The system according to claim 7, wherein the imaging sensor comprises:
a planar array of color filter elements; and
a planar array of photo sensing pixels optical aligned with the color filter elements, each photo sensing pixel comprising at least a photo diode on a semiconductor substrate.

9. The system according to claim 8, wherein the post polarizer is adherently fabricated onto the planar array of color filter elements.

10. The system according to claim 8, wherein the post polarizer is a wire grid polarizer made from elongated reflective metal strips fabricated between the planar array of color filter elements and the planar array of photo sensing pixels.
